(19) United States
(12) Patent Application Publication
(10) Pub. No.: US 2015/0120523 A1
(43) Pub. Date: Apr. 30, 2015

(54) Method and Payment Unit For Controlling an Amount Available For Payment in a Vehicle

(71) Applicant: Telefonaktiebolaget L M Ericsson (publ), Stockholm (SE)

(72) Inventors: Matthew John LAWRENSON, Lausanne (CH); Julian Charles NOLAN, Lausanne (CH)

(73) Assignee: Telefonaktiebolaget L M Ericsson (publ), Stockholm (SE)

(21) Appl. No.: 14/066,221

(22) Filed: Oct. 29, 2013

Related U.S. Application Data
(63) Continuation of application No. PCT/EP2013/072632, filed on Oct. 29, 2013.

(51) Int. Cl. G06Q 40/00; G06Q 50/06

(52) U.S. Cl. CPC G06Q 40/00; G06Q 50/06
USPC 705/35

(57) ABSTRACT

This disclosure provides a method, performed in a payment unit 30,30′ in a vehicle having an energy storage, of controlling an amount available for payment. The method comprises: determining S1 a state of charge of the energy storage of the vehicle, and calculating S2 the amount to be available for payment based on the determined state of charge of the energy storage.

### TECHNICAL FIELD

The invention pertains to the field of controlling or monitoring parameters relating to transferring energy to a vehicle having an energy storage. More particularly the invention pertains to controlling payment amounts to such transfers.

### BACKGROUND

Electrical vehicles are becoming more and more attractive with the advancement of new battery technology resulting in greater possible acceleration and longer driving range with fewer batteries. A typical maximum range for present electrical vehicles is around 100 miles which is not as much as the range of internal combustion engine vehicles, namely 500-700 miles. Therefore, electrical vehicles need more frequent charging than traditional vehicles. The cost of each charging is usually relatively small, in order of $5. With a growing adoption of electrical vehicles and with electrical vehicles mainly relying on frequent payment of small amounts for charging the battery or energy storage, usual payments involving e.g. a credit card or cash seem unnecessarily cumbersome.

There exist today a number of payment systems in vehicles for various purposes. The existing payment systems mainly aim at supporting a fast payment procedure. In e.g. electronic toll systems, or contactless parking payment systems, the vehicle can just drive through a checkpoint e.g. for toll or parking and the toll or parking payment would be handled by the payment system of the vehicle with no interaction from the driver. Convenience is paramount for payment systems in vehicles. However, it is equally essential to ensure security and access control of the payment systems.

Indeed, an attacker could maliciously access the payment system embedded in a vehicle and extract e.g. large amounts. This is emphasized by the fact that the vehicle is always parked away from the user and often in unattended public spaces, thereby offering opportunities for an attacker to act. Therefore, it becomes increasingly important to find a system that is suitable to pay for frequent charging of batteries in vehicles while still providing security.

### SUMMARY

This disclosure discloses a method in a vehicle having an energy storage where an amount is made available for payment of charging or refilling of an energy storage depending on the state of charge of the energy storage. This is accomplished by controlling the amount available for payment to make sure it covers a potential cost for charging or refilling the energy storage.

According to the disclosure, it provides a method, performed in a payment unit in a vehicle having an energy storage, of controlling an amount to be available for payment. The method comprises: determining a state of charge of the energy storage of the electrical vehicle, and calculating the amount to be available for payment based on the determined state of charge of the energy storage. The disclosure provides an advantage in minimizing the overall risk of fund theft in case of an attack as the amount available for the payment service that may be vulnerable to theft is dependent on the current state of charge of the energy storage which makes it limited to a minimum necessary amount.

According to one aspect of this disclosure, the step of calculating the amount to be available for payment comprises estimating an amount required for fully replenishing the energy storage of the vehicle based on at least the determined state of charge of the energy storage.

According to one aspect of this disclosure, the method further comprises obtaining a maximum quantity of energy storable at the energy storage, and the step of calculating the amount to be available for payment comprises calculating the amount based on a difference between the maximum quantity of energy and the determined state of charge of the energy storage. An advantage of taking into account the maximum quantity of energy storable at the energy storage is that the method allows for a maximum cost for next charge to be covered by the amount available for payment, even on the way to a charging station. This results in a faster payment at a charging station.

According to one aspect of this disclosure, the method further comprises determining S1b energy price information and wherein the step S2c of calculating S2 the amount to be available for payment is further based on the determined energy price information. The step of determining S1b energy price information comprises obtaining energy price information. This results in a possibility to provide a more accurate calculation of the amount to be available for payment.

According to another aspect of this disclosure, the method further comprises transferring an amount between a first payment area and a second payment area, so that the calculated amount is available in the second payment area which comprises the amount to be available for payment. This provides an advantage in terms of maximized trade-off between convenience and security for payments related to charging an energy storage.

According to one aspect of this disclosure, the first payment area and the second payment area are comprised in a secure area. A security level of the second payment area is lower that the security level of the first payment area. An effect of this is a gain in flexibility of payment of charges balancing levels of security dynamically while still guaranteeing the adequate security level for each payment area. The method of this disclosure allows for interoperability with any payment scheme as the payment unit and the energy provider do not need to have a prior relationship.

According to one aspect of the disclosure, it relates to a payment unit for controlling an amount available for payment in a vehicle having an energy storage. The payment unit comprises a controller configured to determine a state of charge of the energy storage of the vehicle. The controller is also configured to calculate the amount to be available for payment based on the determined state of charge of the energy storage.

According to one aspect of the disclosure, the payment unit further comprises: a data storage configured to store the amount to be available for payment, and an interface configured to receive from the energy provider a request for payment of the energy charged on the energy storage. The request for payment comprises an amount to be paid corresponding to the energy charged on the energy storage. The controller is further configured to authenticate the energy provider, and if the energy provider is authenticated successfully, the interface is further configured to communicate to the energy provider information enabling the payment of the amount to be paid from the calculated amount available in the second payment area. According to one aspect of the disclosure, it relates to an integrated circuit card configured to perform the method as described above. An integrated circuit card is a suitable host for an application as the one disclosed here that require high level of security.

According to one aspect of the disclosure, it relates to a vehicle comprising a payment unit described above. The vehicle may be an internal combustion engine vehicle or an electrical vehicle. An advantage of a vehicle comprising a payment unit disclosed herein is a smoother, and faster payment at a charging station. This is even more appreciated as one is often on the go and pressured by time when charging an energy storage of a vehicle.

According to one aspect of the disclosure, it relates to a computer program, comprising computer readable code which, when run on a controller of a payment unit causes the payment unit to perform the method as described above.

With the above description in mind, the object of the present disclosure is to overcome at least some of the disadvantages of known technology as described above and below.

### BRIEF DESCRIPTION OF THE DRAWINGS

The present technique will be more readily understood through the study of the following detailed description of the embodiments/aspects together with the accompanying drawings, of which:

FIG. 1 is a flow chart illustrating embodiments of method steps, performed in a payment unit in a vehicle having an energy storage.

FIG. 2 is a flow chart illustrating a method of controlling an amount available for payment according to an exemplary embodiment of the present disclosure.

FIG. 3 is a block diagram illustrating an embodiment of a payment unit for controlling an amount available for payment in a vehicle having an energy storage.

FIG. 4 is a block diagram illustrating an embodiment of an exemplary system comprising a payment unit for controlling an amount available for payment and other entities.

FIG. 5 is a block diagram illustrating an embodiment of an integrated circuit card configured to perform embodiments of method steps for controlling an amount to be available for payment.

FIG. 6 is a block diagram illustrating an embodiment of a payment unit for controlling an amount available for payment embedded in a vehicle.

FIG. 7 is a block diagram illustrating an embodiment of a payment unit for controlling an amount available for payment with the payment unit located outside the vehicle.

It should be added that the following description of the embodiments is for illustration purposes only and should not be interpreted as limiting the disclosure exclusively to these embodiments/aspects.

### DETAILED DESCRIPTION

The general object or idea of embodiments of the present disclosure is to address at least one or some of the disadvantages with the prior art solutions described above as well as below. The various steps described below in connection with the figures should be primarily understood in a logical sense, while each step may involve the communication of one or more specific messages depending on the implementation and protocols used.

The general idea is to provide a payment unit having control over an amount available for payment based on a state of charge of an energy storage in a vehicle. Thereby, the payment process is facilitated for frequent payments of small amounts.

Embodiments of the present disclosure relate, in general, to the field of energy storage charge and payment for vehicles. However, it must be understood that the same principle is applicable in other devices that require a convenient payment system for amounts related to charging an energy storage. For example the method is applicable to a fuel driven vehicle. Then the energy storage is the fuel tank and the state of charge is the fuel level in the fuel tank.

In this application, the term “vehicle” is generally used to refer to a means of transportation. A vehicle may be an electrical vehicle or a fuel driven vehicle. Vehicles comprise a car, a bus, a truck, a segway, a cart, a golf cart, a ship, an aircraft. An electrical vehicle uses one or more electric motors or traction motors for propulsion. An electrical vehicle may be powered by stored electricity originally from an external power source. Electrical vehicles include electric cars, electric trains, electric lorries, electric aero-planes, electric boats, electric motorcycles and scooters and electric spacecraft.

In the present disclosure, the term “energy” refers to for example electrical energy such as electricity or power or liquid energy such as gasoline or diesel. As used herein, the term “electrical energy” refers to energy which has been converted from electrical potential energy.

As used herein the term “energy storage” refers to a physical medium that stores energy to perform operations at a later time. Examples of energy storage include an accumulator, a capacitor, a battery such as a rechargeable battery and a tank. A battery can be for example a lead-acid battery, a Lithium-ion battery, a Nickel metal hydride battery, or a zebra battery. A tank is a container comprising fuel such as gasoline, or petrol.

As used herein the term “energy provider” refers to any entity that generates and distributes energy to its customers, that purchases energy from an energy-generating entity and distributes the purchased energy to its customers, or that supplies energy created by alternative energy sources, such as solar or wind sources to energy distribution entities through a grid or energy network. An energy provider is for example a utility operator, or an electrical grid provider.

As used herein the term “universal integrated circuit card”, UICC, is a smart card with an electronic circuit embedded in it. An embedded UICC takes the principles of UICC but has the circuitry either as a discrete silicon chip mounted as part of a larger system or as a component within a larger circuit.

In this disclosure, the term “charging” or “charge” refers to replenishing or a replenishment of an energy storage. Charging of an energy storage corresponds to refilling of a fuel tank if the vehicle is a fuel driven vehicle.

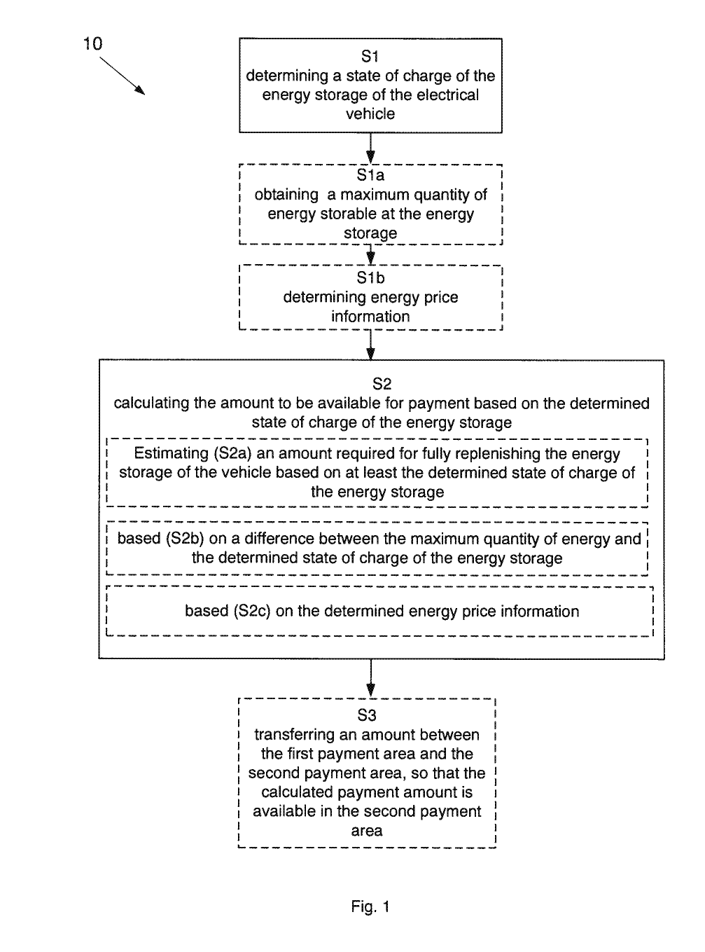

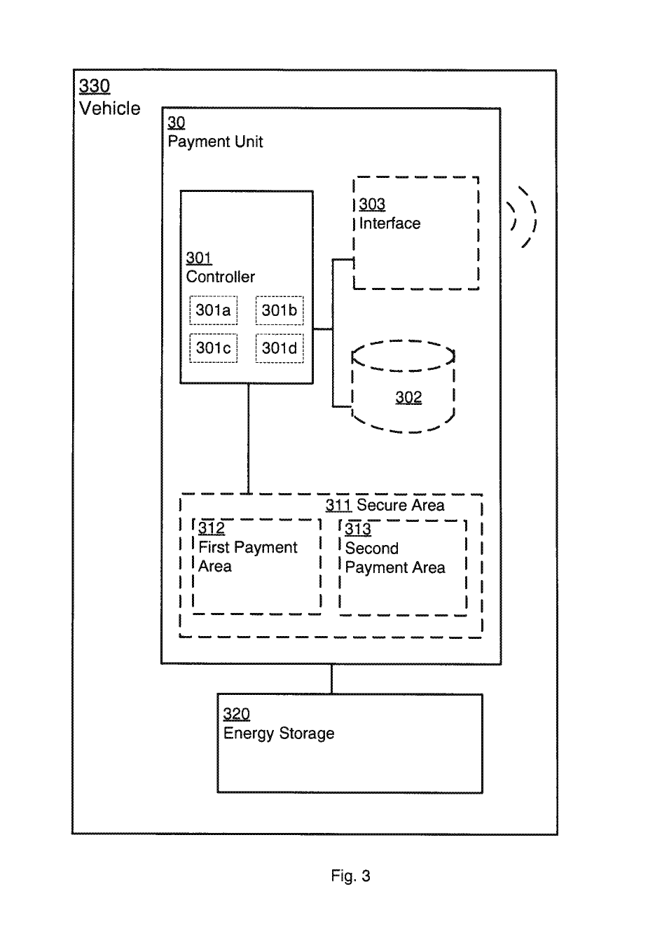

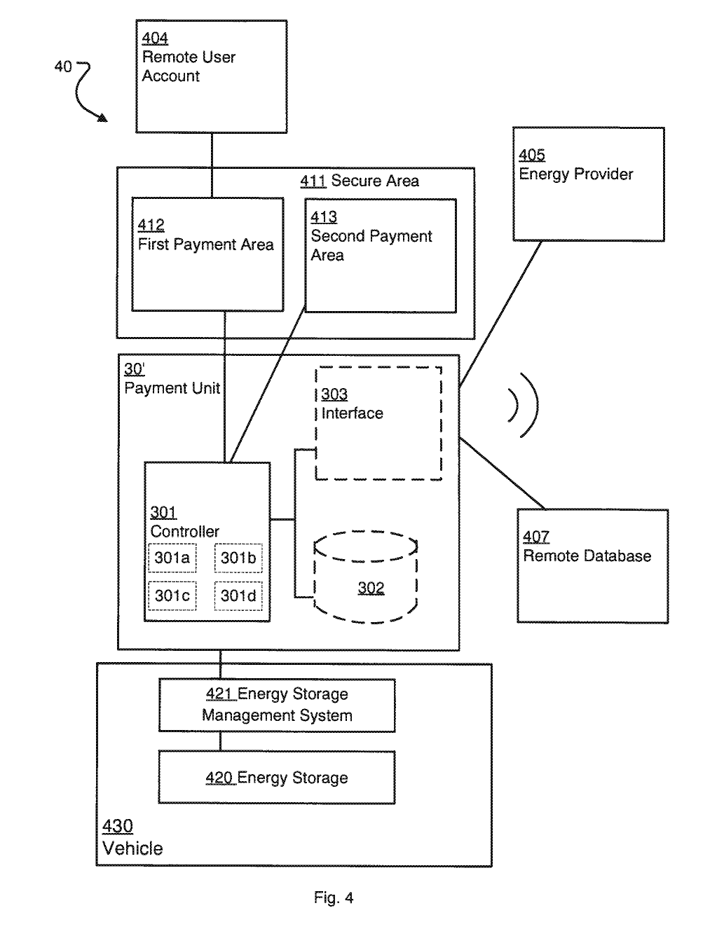

In FIG. 1, a method, performed in a payment unit 30, 30′, shown in FIGS. 3 and 4 and described below, in an electrical vehicle 330 having an energy storage 320, of controlling an amount available for payment, is disclosed.

In the first step S1, the payment unit determines S1 a state of charge of the energy storage of the electrical vehicle. The state of charge of an energy storage is a measurement of the amount of energy available in an energy storage. Units of state of charge may be percentage points (0%=empty; 100%=full). An alternate form of the same measure is the depth of discharge which is the inverse of state of charge (100%=empty; 0%=full). The state of charge is expressed in e.g. Watt-hour, Ampere-hour, or Joule. Determining the state of charge of an energy storage may comprise obtaining the state of charge from an energy storage management system that monitors energy storage information including state of charge, SoC, and maximum quantity of energy storable on the energy storage, which is also called Maximum Charge Level, MCL. Other ways of determining the state of charge of an energy storage involve e.g. assessing the pH of the liquid electrolyte contained in the energy storage, or converting a reading of the voltage of the energy storage to a state of charge, or measuring the battery current and integrating it in time, modeling the energy storage with an electrical model using a Kalman filter, or measuring the internal pressure of the energy storage. For Lithium-ion batteries, a state of charge or discharge of a Lithium-ion battery is assessed based on a measured value of a charge/discharge current of the Lithium-ion battery, a measured value of the temperature of the battery, and information of supply of electricity of a commercial power supply.

In the next step S2, the payment unit 30, 30′ calculates S2 the amount to be available for payment based on the determined state of charge of the energy storage. The amount to be available for payment is an amount that covers the cost of charging the energy storage of the vehicle in question from a current state of charge to e.g. a maximum quantity of energy storable on the energy storage.

According to one aspect of this disclosure, the step S2a of calculating S2 the amount to be available for payment comprises estimating an amount required for fully replenishing the energy storage of the vehicle based on at least the determined state of charge of the energy storage. Alternatively, the amount to be available may be calculated as the amount required for replenishing the energy storage up to a certain percentage of the maximum quantity of energy storable such as 80%, 90%. Also the amount to be available may be calculated as the amount required for replenishing the energy storage sufficiently so that the vehicle is able to reach a final destination such as home or office.

Calculating the amount to be available for payment involves energy price information that may be anticipated or provided. The amount to be available for payment may be considered as a Maximum Cost of Next Charge, MCONC or a maximum cost of ongoing charge. Calculating the amount to be available for payment based on the state of charge of the energy storage allows a dynamic adjustment of the amount to be available for payment.

According to one aspect of this disclosure, the payment unit 30, 30′ obtains S1a a maximum quantity of energy storable at the energy storage and the step S2b of calculating S2 the amount to be available for payment comprises calculating the amount based on a difference between the maximum quantity of energy and the determined state of charge of the energy storage. The maximum quantity of energy storable at the energy storage corresponds to the maximum charge level, MCL, monitored by the energy storage management system. After obtaining the MCL, the payment unit 30, 30′ is able to assess the quantity of additional energy necessary to reach the MCL from the SoC. The quantity of additional energy necessary to reach the MCL from the SoC is the difference between SoC and MCL expressed in energy units.

According to one aspect of this disclosure, the method further comprises determining S1b energy price information and wherein the step S2c of calculating S2 the amount to be available for payment is further based on the determined energy price information. The step of determining S1b energy price information comprises obtaining energy price information. The energy price information may be obtained by receiving it from an energy provider, a market indexes provider, an energy broker, or an energy pricing aggregator. The energy price information may also be obtained by reading a memory accessible to the payment unit, e.g. for a pre-programmed energy price information, or by anticipating the energy price information based on e.g. a previously obtained energy price information, or an average over a plurality of previously obtained energy price information. The amount to be available for payment may be calculated by multiplying the received energy price information with the difference between the maximum quantity of energy and the determined state of charge of the energy storage. Energy price information is information allowing to derive a price of energy expressed in currency unit per energy unit, such as USD per Watt-hour.

According to one aspect of this disclosure, the payment unit 30, 30′ then transfers S3 an amount between a first payment area 312, 412 and a second payment area 313, 413, so that the calculated amount is available in the second payment area 313, 413 which comprises the amount to be available for payment. The second payment area 313, 413 is a payment area accessible to the energy provider. The second payment area 313, 413 comprises for example information enabling a payment corresponding to the potential cost of the additional quantity of energy necessary to reach MCL from the SoC, i.e. the maximum cost of next charge, MCONC. The first payment area 312, 412 is a payment area that is not accessible to the energy provider. The first payment area 312, 412 comprises for example an amount at least as large as the MCONC, if not larger. The amount to be available is calculated prior to any payment, and is therefore anticipated to be the expected amount for payment of next charge. Adjusting by transfer the amount available in the second payment area 313, 413 is also performed prior to any payment. An advantage is a faster and more seamless payment of the charge at a charging station as the amount for payment of charging costs is readily available.

According to one aspect of this disclosure, the first payment area 312, 412 and the second payment area 313, 413 are comprised in a secure area 311, 411. The secure area 311, 411 may be a secure execution environment, or a secure component or a UICC with a subscriber identity module, SIM. Access to the secure area 311, 411 can for example be restricted to authenticated users or entities.

According to one aspect of this disclosure, the secure area 311 is located inside the payment unit 30. According to another aspect of this disclosure, the secure area 411 is located outside the payment unit 30′. The secure area 311, 411 may be embedded in the payment unit or embedded in the vehicle outside the payment unit. Whether the secure area 311, 411 is located inside or outside the payment unit, the payment unit interacts with the secure area 311, 411 in similar ways. If the secure area 411 is located outside the payment unit 30′, a secure communication links needs to be established between the payment unit 30′ and the secure area 311, 411. In one embodiment, the secure area 411 is comprised in a handheld device such as a mobile phone, or a tablet, that is independent of the vehicle. The secure area 311, 411 may also be comprised in an integrated circuit card, that may be inserted in a handheld device or in a payment unit 30′ of the vehicle.

According to one aspect of this disclosure, a security level of the second payment area 313, 413 is lower that the security level of the first payment area 312, 412. A security level is related to e.g. an authentication level based on a number of factors used and security of the factors. Authentication is for example either ‘one-factor’, ‘two-factor’, or three-factor′ which means that one out of three authentication factors is used, two out of three authentication factors are used, or all three are used respectively. The three factors are for example an ownership factor (i.e. based on a possession of an item such as a card or a smart phone), a knowledge factor (i.e. knowledge of some information such as a password or Personal Identification Number, PIN), and an inherence factor (i.e. something a person inherently is or does, such as fingerprint or voice identification). A factor can be more or less secure. For example, a knowledge factor can be something simple and likely to be known by others (e.g. a person's name) or more complex (e.g. a long complex password). Similarly an ownership factor is for example the possession of an electronic key where the key can be more secure (i.e. encrypted) or less secure (i.e. stored as readable text). An authentication protocol is considered at a ‘lighter’ end of the security spectrum if the authentication protocol is based on a single factor that is likely to be known to others—e.g. a person's family name. A ‘more secure’ end of the spectrum is a multi-factor authentication based on a well-guarded secret e.g. an ownership factor that is encrypted, combined with a knowledge factor that is complex and not widely known. Access to the first payment area 312, 412 requires for example a multi-factor authentication based on e.g. well-guarded secret while access to the second payment area 313, 413 requires for example a single factor authentication based e.g. 4-digits PIN number. This way, the first payment area 312, 412 comprising a (likely larger) amount is highly secure while the second payment area 313, 413 comprising a (likely smaller) amount available for payment is protected with a security scheme that is convenient to use frequently. The risk of attacks is further emphasized when the method is carried out in a vehicle that is often parked away from the owner. Attackers have more accessibility to the payment unit during the parking time. Providing two different security levels for each payment area results in a flexible system allowing larger amounts to be highly protected from attacks and smaller amounts for payments to be convenient to access. The payments are thus made quick and easy while lowering the risk of theft of the larger amounts.

According to one aspect of this disclosure, at least one of the first payment area 312, 412 and the second payment area 313, 413 is a digitalwallet. A digital wallet refers to an electronic device that allows an individual to make electronic commerce transactions. This includes purchasing items online with a computer comprising a digital wallet or using a handheld device such as a smart phone comprising a digital wallet to purchase something at a store, e.g. to enable a payment of a charge of an energy storage of a vehicle. A digital wallet may be comprised in a UICC.

According to one aspect of this disclosure, the first payment area 312, 412 comprises a first amount transferred from a remote user account 404, and the second payment area 313, 413 comprises a second amount corresponding to the amount to be available for payment, the second amount being adjusted using a transfer to or from the first payment area 312, 412. The transfer from the remote user account 404 to the first payment area 312, 412 requires a multi-factor authentication or an authentication that uses a security factor with a strong mechanism. The amount transferred from the remote user account 404 may be approved by an external party (e.g. a bank or another payment service). The amount transferred may be represented by a value stored in a data storage connected to the first payment area. In another embodiment, the user accesses the remote user account 404 via a website and requests that a certain amount is transferred to the first payment area 312, 412. In yet another embodiment, the website initiates a connection with the payment unit 30, 30′ via a machine-to-machine communication using the cellular network and a SIM belonging to the user.

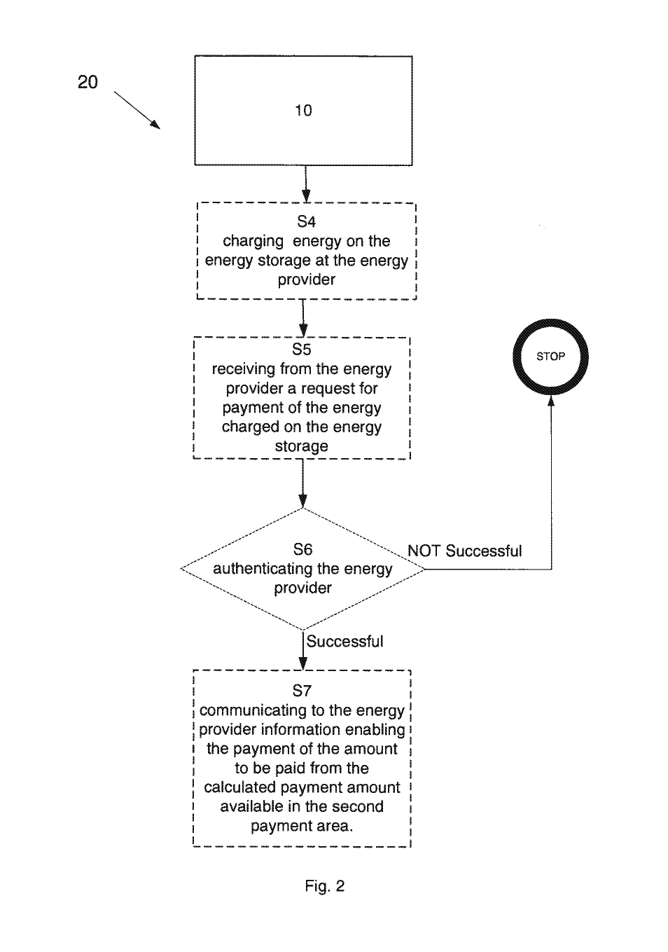

In FIG. 2, the method of controlling an amount available for payment according to one aspect of the present disclosure is disclosed. The method disclosed in FIG. 2 is consecutive to the method disclosed in FIG. 1. In step S4, the method comprises charging S4 energy on the energy storage at an energy provider 405. This corresponds to the payment unit 30, 30′ triggering the charging and/or obtaining information about the energy being charged on the energy storage at an energy provider 405. The charging takes place at a charging station of the energy provider 405. In the next step S5, the payment unit 30, 30′ receives S5 from the energy provider 405 a request for payment of the energy charged on the energy storage. The request for payment comprises an amount to be paid corresponding to the energy charged on the energy storage. The amount to be paid to the energy provider corresponds to the cost of the energy charged on the energy storage. The amount to be paid may be equal or less than the amount available for payment in the second payment area 313, 413, calculated earlier (e.g. MCONC). If the amount to be paid ends up being greater than the amount available for payment in the second payment, then the payment unit 30, 30′ transfers from the first payment area 312, 412 to a second payment area 313, 413 the difference between the MCONC and the amount to be paid.

In the following step S6, the payment unit 30 authenticates S6 the energy provider 405. Authentication of the energy provider 405 is performed for example by verifying the energy provider credentials, using e.g. a challenge/response protocol or verifying the energy provider digital signature.

In step S7, if the energy provider 405 is authenticated successfully, the payment unit 30, 30′ communicates S7 to the energy provider 405 information enabling the payment of the amount to be paid from the calculated payment amount available in the second payment area 313, 413. Information enabling the payment of the amount to be paid comprises e.g. the amount to be paid and a set of credentials of the payment unit 30, 30′ so that the energy provider can authenticate the payment unit. The credentials are for example a simple 4-digit PIN number or the vehicle owner's name, depending on what type of authentication is prescribed between the payment unit and the energy provider. If the authentication of the energy provider 405 is not successful, then the payment unit 30, 30′ rejects the request for payment. While the payment unit 30, 30′ manages the payment authorization, the actual transfer of the payment amount may be for example performed from a remote user account to an account of the energy provider, possibly via a third party.

According to one aspect of the proposed technique, the step of calculating S2 an amount to be available for payment is further based on contextual data stored in a remote database 407. Contextual data comprises e.g. at least one of a distance, a time, a speed, location information, or a maximum quantity of energy storable on the energy storage. The payment unit 30, 30′ may calculate the amount to be available for payment further based on contextual data. For example, the payment 30, 30′ may perform the calculation based on contextual data while the energy storage is being depleted (e.g. due the vehicle being driven), e.g. away from a charging station. To calculate the amount to be available for payment further based on contextual data, the payment unit 30, 30′ performs for example the following steps. The payment unit 30, 30′ obtains a distance from a present location to a nearby charging station and price information of the energy, of e.g. an energy unit, at the nearby charging station. Then, the payment unit 30, 30′ calculates a state of charge expected at the nearby charging station based on the current state of charge of the energy storage and the distance to the nearby charging station. The payment unit 30, 30′ calculates a difference between the SoC expected at the nearby charging station and the maximum quantity of energy storable on the energy storage (i.e. MCL). Finally, the payment unit 30, 30′ calculates an amount to be available for payment based on the calculated difference and the obtained price information of the energy at the nearby charging station. This way the amount available in the second payment area 313, 413 can be adjusted to the calculated amount to be available for payment, so that at the charging station the payment of the charge can be performed in a faster and more seamless way while still ensuring a security level. This results in a smoother payment as the calculations and the transfer of the expected amount for payment is already available in the second payment area 313, 413 prior to charging, e.g. when the vehicle is on its way at the charging point.

According to one aspect of the proposed technique, the step S2 of calculating an amount to be available for payment is performed periodically or at a predetermined incremental event of depletion of the energy storage. The payment unit 30, 30′ performs the calculation of the amount to be available for payment at a set time interval, or at a set time interval when the energy storage is being depleted. The payment unit 30, 30′ performs the calculation of the amount to be available for payment for example at each determination of the SoC of the energy storage, such as at a reception of a data indicative of the SoC from an energy storage management system.

In yet another aspect of this disclosure, the amount to be available for payment is in a digital currency. A digital currency may be a code representing a traditional currency or electronic money that acts as alternative currency to the traditional currency. The digital currency is for example a crypto-currency such as a bitcoin, a litecoin, a namecoin or a PPcoin, which are widely known digital currencies. If the energy provider accepts to be paid in digital currency, then the payment unit 30, 30′ computes the amount to be available for payment in the digital currency. The amount transferred from the remote user account 404 to the first payment area 312, 412 is then provided in the digital currency as well as the amount to be paid to the energy provider. The digital currency may be stored in a UICC containing a SIM.

Turning now to FIG. 3, a schematic diagram illustrating some modules of an exemplary embodiment of a payment unit 30, 30′ for controlling an amount available for payment in a vehicle 330 having an energy storage 320 is described. According to one aspect, the payment unit 30, 30′ comprises a controller 301 configured to determine S1 a state of charge of the energy storage of the electrical vehicle 330, and configured to calculate S2 the amount to be available for payment based on the determined state of charge of the energy storage. Hence, the controller 301 may comprise a determiner 301a, and a calculator 301b. The determiner 301a is configured to determine a state of charge of the energy storage of the vehicle 330. The calculator 301b is configured to calculate S2 the amount to be available for payment based on the determined state of charge of the energy storage 320.

The controller 301 may be constituted by any suitable Central Processing Unit, CPU, microcontroller, Digital Signal Processor, DSP, etc. capable of executing computer program code. According to one aspect the disclosure relates to a payment unit 30, 30′ for controlling an amount available for payment in a vehicle having an energy storage, comprising a processor 301 and a memory, said memory containing instructions executable by said processor, to execute the method described herein.

According to one aspect of this disclosure, the determiner 301a is further configured to obtain a maximum quantity of energy storable at the energy storage and the calculator 301b is further configure to calculate the amount to be available for payment based on the difference between the maximum quantity of energy and the determined state of charge of the energy storage. After obtaining the maximum quantity of energy storable (i.e. MCL), the controller 301 is able to assess the quantity of additional energy necessary to reach the maximum quantity of energy storable from the current SoC. The quantity of additional energy necessary to reach the maximum quantity of energy storable from the SoC is the difference between SoC and maximum quantity of energy storable expressed in energy units.

According to one aspect of this disclosure, the controller 301 is further configured to determine Slb energy price information; and wherein the controller 301 is further configured to perform the step S2c of calculating S2 the amount to be available for payment based on the determined energy price information. The determiner 301a is configured to determine Slb energy price information. The determiner 301a either obtains energy price information by receiving it, by reading it, or by anticipating it. The calculator 301b is configured to calculate S2c the amount to be available for payment based on the determined state of charge of the energy storage and the determined energy price information. The calculator 301b calculates the amount to be available for payment based on the determined energy price information the difference between SoC and maximum quantity of energy storable.

According to one aspect of this disclosure, the controller 301 further comprises a payment amount transferring module 301c configured to transfer S3 an amount between a first payment area 312, 412 and a second payment area 313, 413 so that the calculated amount is available in the second payment area 313, 413 which comprises the amount to be available for payment. The first payment area 312, 412 and the second payment area 313, 413 are comprised in a secure area 311, 411. The controller 301 is configured to control the first payment area 312, 412 and the second payment area 313, 413. The controller 301 can thus use the payment amount transferring module 301c to transfer an amount between the first payment area 312, 412 and the second payment area 313, 413. If there is an amount stored in the second payment area, the controller 301 is configured to verify whether the amount already stored in the second payment area 313, 413 is sufficient to cover the calculated amount to be available. If the controller 301 determines that the amount already stored in the second payment area is larger than the calculated amount to be available in the second payment area, then the payment amount transferring module 301c reduces the amount already stored in the second payment area 313, 413 by transferring to the first payment area 312, 412 the difference between the amount already stored and the calculated amount to be available. If the controller 301 determines that the amount already available is smaller than the calculated amount to be available in the second payment area, then the payment amount transferring module 301c increases the amount already available in the second payment area 313, 413 by transferring the difference from the first payment area 312, 412 to the second payment 312, 412 area. Adjusting the amount in the second payment area according to the above has the effect of providing only the necessary amount in the second payment area, thereby limiting the risk of theft only to the necessary minimal amount.

According to one aspect of this disclosure, the payment unit 30, 30′ further comprises a data storage 302 configured to store the amount to be available for payment and a communication interface 303 configured to receive from the energy provider 405 a request for payment of the energy charged on the energy storage 320, the request for payment comprising an amount to be paid corresponding to the energy charged on the energy storage 320. The controller 301 is further configured to receive S5 via interface 303 from the energy provider 405 a request for payment of the energy charged on the energy storage. The request for payment comprises an amount to be paid corresponding to the energy charged on the energy storage. The request for payment may be received via the interface 303. The controller 301 is further configured to authenticate S6 the energy provider 405. If the energy provider 405 is authenticated successfully, the interface 303 is further configured to communicate S7 to the energy provider 405 information enabling the payment of the amount to be paid from the calculated amount available in the second payment area 403. Hence, the controller 301 further comprises an authenticator 301d to authenticate the energy provider or a charging station of the energy provider. If the authenticator 301d authenticates the energy provider successfully, then the interface 303 communicates to the energy provider 405 information enabling the payment of the amount to be paid from the second payment area 313, 413. The interface comprises a wireless communication interface. The interface may be supporting short-range communications (e.g. RFID, NFC, WiFi, Bluetooth) or cellular communications. The data storage 302 may be a memory. The memory can be any combination of a Read And write Memory, RAM, and a Read Only Memory, ROM. The memory may also comprise persistent storage, which, for example, can be any single one or combination of magnetic memory, optical memory, or solid state memory or even remotely mounted memory.

FIG. 4 discloses an exemplary system 400 comprising a payment unit 30′ for controlling an amount available for payment and other entities. The payment unit 30′ comprises a controller 301, and possibly a data storage 302 and a communication interface 303. The payment unit 30′ controls the secure area 411 that is located outside payment unit 30′ and comprises the first payment area 412 and the second payment area 413. The payment unit 300 is also connected to the energy storage management system 421 of energy storage 420 of vehicle 430 from which the payment unit 30′ obtains information related to the state of charge of the energy storage, and information related to the quantity of energy being charged. The payment unit 30′ is further connected to the energy provider 405 and a remote database 407 storing e.g. contextual data. Furthermore, the first payment area 412 is connected to a remote user account 404.

In an illustrative example of where the proposed technique is applicable, we assume that the payment unit 30, 30′ is embedded in a UICC, which comprises a SIM configured for machine-to-machine, M2M, communication and is embedded in a vehicle. The energy storage 320 is in an electrical vehicle 330 which is being driven. The energy storage is thus being depleted, and experiences a reducing state of charge, SoC. The energy storage management system 421 monitors the current SoC and reports it, via M2M communication, to the payment unit 30, 30′. The controller 301 obtains from the remote database 407 the geographic location of the electrical vehicle 330, the distance to at least one nearby charging station and energy price information. When geographic location changes by a set amount, the payment unit 300 requests the value of the likely cost of energy at the at least one nearby charging station. The value of the likely cost of energy is obtained by payment unit 300. At a set polling interval, the calculator 301b calculates the maximum cost of next charge, MCONC, which is the amount to be available for payment as follows. The calculator 301b calculates the amount A of energy required to increase the energy level of the energy storage from the current SoC to the maximum charge level which is the maximum quantity of energy storable in the energy storage. The calculator 301b may additionally calculate the likely energy expended before the next polling event as additional amount B of energy required for full charge. The calculator 301b then calculates the total amount T of energy required for full charge: T=A+B. The calculator 301b finally calculates the amount to be available for payment (or MCONC) by multiplying T with the likely cost of energy obtained. The controller 301 then checks if the second payment area 312, 412 has the ability to enable the calculated amount to be available for payment. If the controller 301 determines that the amount already stored is larger than the calculated amount to be available in the second area, then the payment amount transferring module 301c reduces the amount already stored in the second payment area 313, 413 by transferring to the first payment area 312, 412 the difference between the amount already stored and the calculated amount to be available. If the controller 301 determines that the amount already stored is less than the calculated amount to be available in the second area, then the payment amount transferring module 301c increases the amount already stored in the second payment area 313, 413 by transferring from the first payment area 312, 412 to the second payment 312, 412 area the difference between the amount already stored and the calculated amount to be available. Once the energy storage 420 has been charged at a charging station of the energy provider 405, the energy provider 405 sends a request for payment to the payment unit 300. The authenticator 301d of payment unit 300 authenticates the energy provider. If the authenticator 301d authenticates the energy provider successfully, then the interface 303 communicates to the energy provider 405 information enabling the payment of the amount to be paid from the second payment area 313, 413.

The polling of data from the remote database 407 may be dependent on various factors, e.g. time passed, distance traveled, charge expended, or the electrical vehicle 330, 430, 530, 630 crossing a geographic boundary.

The present disclosure further relates to an integrated circuit card 50 configured to perform the method disclosed here. The integrated circuit card may be a UICC containing a SIM. SIM contains either hardware or software that includes unique identifiers and authentication keys allowing an individual subscriber to be identified in communication network. Such a UICC containing a SIM is a suitable host for applications as the one disclosed here that require high level of security.

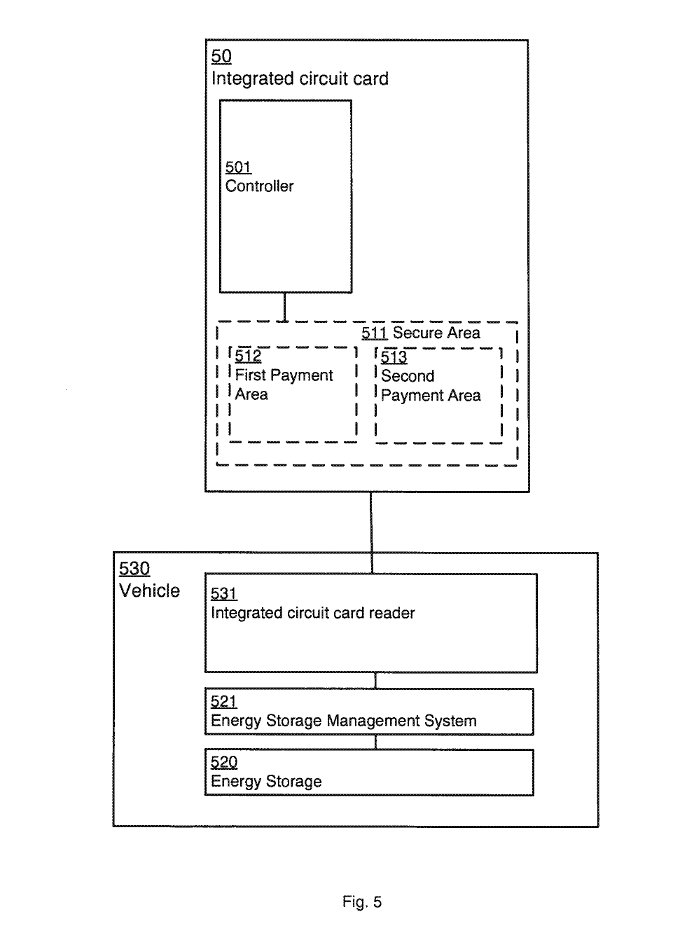

FIG. 5 shows a block diagram illustrating an embodiment of an integrated circuit card 50 configured to perform embodiments of method steps for controlling an amount to be available for payment. FIG. 5 shows a vehicle 530 comprising an energy storage 520 and an integrated circuit card reader 531. The integrated circuit card reader 531 is configured to read the integrated circuit card 50 and to allow the integrated circuit card 50 to communicate with the energy storage management system 521 of the energy storage 520.

The present disclosure further relates to a vehicle comprising a payment unit 30, 30′ for controlling an amount available for payment. An energy storage equipped in the vehicle discharges during the traveling of the vehicle. For example, let us assume an electrical vehicle returning home at the end of the trip and is parked. A connection port provided in the home is connected to the electricity supply port provided on the electric vehicle, and the energy storage is charged until the next morning. In such a scenario, there is no need for payment at a charging station. Thus the controller 301 of the payment unit 30, 30′ uses the payment amount transferring module 301c to transfer the amount available in the second payment area 313, 413 to the first payment area 312, 412 where the amount is more secure against theft.

According to one aspect of this disclosure, the method is performed in a payment unit 30, 30′ embedded in the vehicle. Embedding the payment unit 30, 30′ in the vehicle involves giving a dedicated payment function to the payment unit within a larger mechanical-electrical system i.e. the vehicle, often with real-time computing constraints. The payment unit 30, 30′ is embedded as part of the complete vehicle, possibly including hardware parts. Embedding the payment unit in the vehicle facilitates the interoperability of the payment unit 30, 30′ with e.g. the energy storage management system.

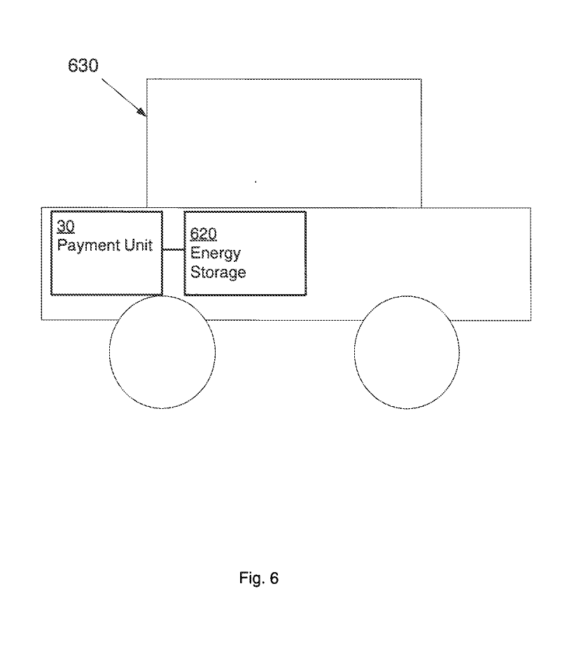

FIG. 6 is a block diagram illustrating an embodiment of a payment unit 30 for controlling an amount available for payment embedded in a vehicle 630. FIG. 6 shows a vehicle 630 comprising an energy storage 620 and a payment unit 30. The payment unit 30 is as described in FIG. 3, and is additionally embedded in vehicle 630 as part of the complete vehicle 630.

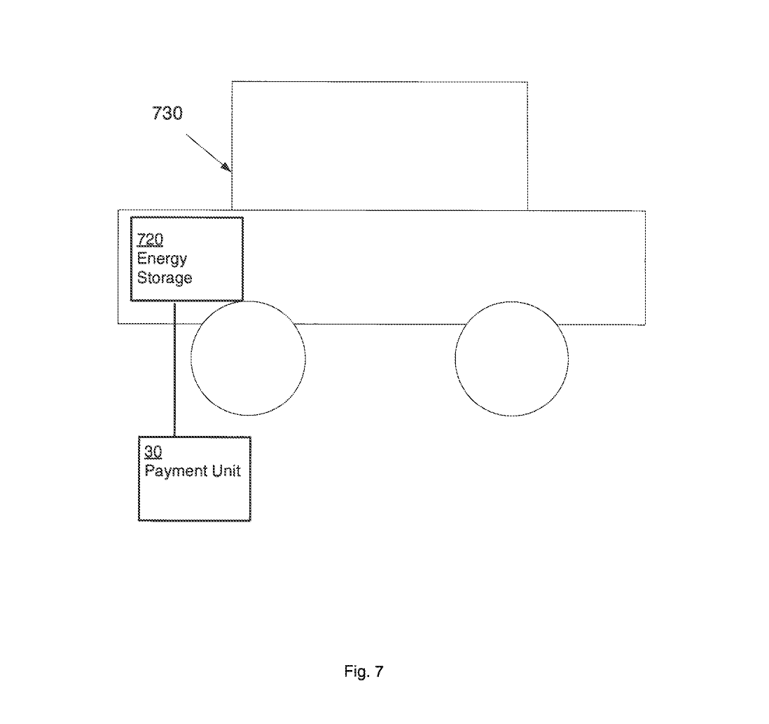

FIG. 7 is a block diagram illustrating an embodiment of a payment unit 30 for controlling an amount available for payment with the payment unit 30 located outside the vehicle 730. The vehicle 730 comprises an energy storage 720. The payment unit 30 is configured to communicate with the energy storage 720 via interface 303 to support the controller 301 in determining the state of charge of the energy storage 720. The payment unit 30 may be comprised in a handheld device such as a mobile phone or a tablet.

According to one aspect of the disclosure, it relates to a computer program, comprising computer readable code which, when run on a payment unit causes the payment unit to perform the method as described above. When the above-mentioned computer program code is run in the controller 301 of the payment unit 30, 30′ it causes the payment unit 30, 30′ to control an amount available for payment in an electrical vehicle having an energy storage according to the method described above.

1. A method, performed in a payment unit in a vehicle having an energy storage, of controlling an amount to be available for payment, the method comprising:
determining a state of charge of the energy storage of the vehicle;
calculating the amount to be available for payment based on the determined state of charge of the energy storage.

2. The method according to claim 1, wherein the step of calculating the amount to be available for payment comprises estimating an amount required for fully replenishing the energy storage of the vehicle based on at least the determined state of charge of the energy storage.

3. The method according to claim 1, further comprising:
obtaining a maximum quantity of energy storable at the energy storage;
wherein the step of calculating the amount to be available for payment comprises calculating the amount based on a difference between the maximum quantity of energy and the determined state of charge of the energy storage.

4. The method according to claim 1, further comprising:
determining energy price information; and
wherein the step of calculating the amount to be available for payment is further based on the determined energy price information.

5. The method according to claim 4, wherein the step of determining energy price information comprises obtaining energy price information.

6. The method according to claim 1, further comprising:
transferring an amount between a first payment area and a second payment area, so that the calculated amount is available in the second payment area which comprises the amount to be available for payment.

7. The method according to claim 6, wherein the first payment area and the second payment area are comprised in a secure area.

8. The method according to claim 6, wherein a security level of the second payment area is lower than the security level of the first payment area.

9. The method according to claim 6, wherein at least one of the first payment area and the second payment area is a digital wallet.

10. The method according to claim 1, wherein the payment unit is embedded in the vehicle.

11. The method according to claim 6, wherein the first payment area comprises a first amount transferred from a remote user account, and the second payment area comprises a second amount, the second amount being adjusted using a transfer to or from the first payment area in order for the second amount to comprise the amount to be available for payment.

12. The method according to claim 5, further comprising:
charging energy on the energy storage at an energy provider;
receiving from the energy provider a request for payment of the energy charged on the energy storage, the request for payment comprising an amount to be paid corresponding to the energy charged on the energy storage;
authenticating the energy provider; and
if the energy provider is authenticated successfully, communicating to the energy provider information enabling the payment of the amount to be paid from the calculated payment amount available in the second payment area.

13. The method according to claim 1, wherein the step of calculating an amount to be available for payment is further based on contextual data stored in a remote database.

14. The method according to claim 13, wherein the contextual data comprises at least one of: a distance, a time, a speed, location information, and a maximum quantity of energy storable on the energy storage.

15. The method according to claim 1, wherein calculating an amount to be available for payment is performed periodically or at a predetermined incremental event of depletion of the energy storage.

16. The method according to claim 1, wherein the amount to be available for payment is in a digital currency.

17. A payment unit for controlling an amount available for payment in an vehicle having an energy storage, the payment unit comprising:
a controller configured to:
determine a state of charge of the energy storage of the vehicle; and
calculate the amount to be available for payment based on the determined state of charge of the energy storage.

18. The payment unit according to claim 17, wherein the controller is further configured to obtain a maximum quantity of energy storable at the energy storage; wherein the controller is further configured to perform the step of calculating the amount to be available for payment based on the difference between the maximum quantity of energy and the determined state of charge of the energy storage.

19. The payment unit according to claim 17, wherein the controller is further configured to determine energy price information; and wherein the controller is further configured to perform the step of calculating the amount to be available for payment based on the determined energy price information.

20. The payment unit according to claim 17, wherein the controller is further configured to transfer an amount between a first payment area and a second payment area so that the calculated amount is available in the second payment area which comprises the amount to be available for payment.

21. The payment unit according to claim 20, wherein the first payment area and the second payment area are comprised in a secure area.

22. The payment unit according to claim 17, further comprising:
a data storage configured to store the amount to be available for payment;
an interface configured to receive from the energy provider a request for payment of the energy charged on the energy storage, the request for payment comprising an amount to be paid corresponding to the energy charged on the energy storage;
the controller is further configured to authenticate the energy provider;
If the energy provider is authenticated successfully, the interface is further configured to communicate to the energy provider information enabling the payment of the amount to be paid from the calculated amount available in the second payment area.

23. An integrated circuit card configured to perform the method of claim 1.

24. A vehicle comprising a payment unit according claim 17.

25. A computer program comprising a non-transitory computer readable medium comprising computer readable code which, when run on a controller of a payment unit, causes the payment unit to perform the method as claimed in claim 1.
